(19) United States
(12) Patent Application Publication
(10) Pub. No.: US 2007/0055789 A1
(43) Pub. Date: Mar. 8, 2007

(54) Method and apparatus for managing routing of data elements

(76) Inventors: Benoit Claise, Crisnee (BE); Stefano Benedetto Previdi, Rome (IT)

Correspondence Address: HICKMAN PALERMO TRUONG & BECKER, LLP, 2055 GATEWAY PLACE, SUITE 550, SAN JOSE, CA, 95110, US

(21) Appl. No.: 11/223,379

(22) Filed: Sep. 8, 2005

(51) Int. Cl. G06F 15/16

(52) U.S. Cl. 709/234

(57) ABSTRACT

A method of managing routing of data elements, each having a plurality of characteristics having a respective attribute, in a data communications network, comprises: creating a flow record of data elements having common attributes for one or more tracked characteristics. The method further comprises defining said flow record as a trackable object; tracking a state change of said trackable an object; and performing a routing management step upon occurrence of a tracked state change.

### FIELD OF THE INVENTION

The present invention generally relates to routing of data elements. The invention relates more specifically to a method and apparatus for managing routing of data elements.

### BACKGROUND OF THE INVENTION

The approach described in this section could be pursued, but are not necessarily approaches that have been previously conceived of pursued. Therefore, unless otherwise indicated herein, the approaches described in this section are not prior art to the claims in this application and are not admitted to be prior art by inclusion in this section.

Various routing management tools are available for managing routing of data elements such as data packets in a data communication network such as the Internet. One such tool is Optimized Exit Routing (OER), described in “Cisco Optimized Edge Routing Deployment Guide” which is available at the time of this writing on the file “networking_solutions_whitepaper09186a008022dbfa.shtml” in the directory” enS/netso1/ns471” of the domain “cisco.com” on the World Wide Web.

The OER feature will be well known to the skilled reader and so is described only in summary here. In particular the OER feature tracks the throughput, utilization, reachability and packet loss rate of a per-destination based and takes appropriate actions to manage routing in order, for example, to increase traffic performance. Referring to FIG. 1 which is an illustrative network diagram, the operation of OER can be understood in more detail. For example where a first autonomous system ASI, reference numeral 100, comprises a network of routers 102,104, 106 which communicate with one another via Interior Gateway protocol (IGP) and with another autonomous system AS2, reference 108, via Border Gateway Protocol (BGP). The routers in AS1 include edge routers 102, 104 communicating with AS2. Router 106 comprises a master controller which collects information on data traffic flows from routers 102, 104 and adjusts BGP routing accordingly. The master controller 106 may obtain the relevant information in various manners including using passive monitoring implementing, for example, the Netflow™ feature of Cisco IOS® Software, commercially available from Cisco Systems, Inc, San José, Calif., USA. Using Netflow, packets sharing a common characteristic attribute such as a common source and destination IP address are classed as a single flow and cached as a corresponding flow record having a record value such as the number of packets or bytes in the flow. The master controller collates flow records to establish whether pre-determined performance characteristics are being met and takes appropriate action, for example, determined by appropriate policies, such as routing packets for a given destination through an alternative edge router. For example in the diagram shown in FIG. 1, where there is a very high flow for a destination in AS2 through router 102, the master controller may load-balance by ensuring that some of the flow is directed through router 104.

In the realm of network security management, flow records may be exported to an external application for further security analysis. One such application is available from ARBOR Networks, Lexington, Mass., USA. A further such application comprises the Cisco Security Monitoring, Analysis and Response System (Cisco Security MARS), a successor to products from Protego Networks, Inc, Sunnyvale, Calif., USA. Such external applications detect anomalies in flows based on determination of specific flow behaviour. For example the applications may identify flows with identical source and destination IP addresses but different destination ports, or may use statistical analysis to detect abnormalities and in particular malicious attempts. In those circumstances an access-list (ACL) is created to allow filtering of malicious flows.

However existing applications do-not permit dynamic adaptation to malicious attempts but rely on static configurations of routers meaning that repetitive intrusion attempts are processed in the same manner each time.

### BRIEF DESCRIPTION OF THE DRAWINGS

FIG. 1 is a representation of a network implementing OER;

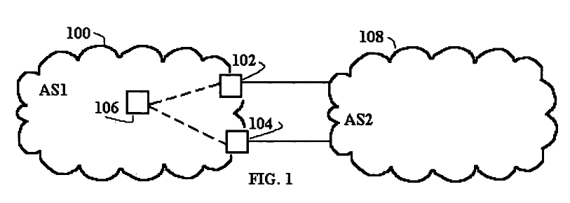

FIG. 2 is a flow diagram illustrating at a high level steps performed in managing routing of data elements applied to network security management;

FIG. 3 is a flow diagram illustrating at a low level steps performed in managing routing of data elements;

FIG. 4 is a flow diagram illustrating steps performed at a remote router in managing routing of data elements;

FIG. 5 is a flow diagram illustrating the method applied to BGP nexthop throughput;

FIG. 6 is a flow diagram illustrating the method applied to QoS;

FIG. 7 is a flow diagram illustrating the method applied to traffic per autonomous system;

FIG. 8 is a flow diagram illustrating the method applied to VoIP gateway traffic;

FIG. 9 is a flow diagram illustrating the method applied to peer to peer traffic; and

FIG. 10 is a block diagram that illustrates a computer system on which a method of managing routing may be implemented.

### DETAILED DESCRIPTION OF THE PREFERRED EMBODIMENT

A method and apparatus for managing routing of data elements is described. In the following description, for the purposes of explanation, numerous specific details are set forth in order to provide a thorough understanding of the present invention. It will be apparent, however, to one skilled person in the art that the present invention may be practiced without these specific details. In other instances, well-known structures and devices are shown in block diagram form in order to avoid unnecessarily obscuring the present invention.

Embodiments are described herein according to the following outline:
1.0 General Overview
2.0 Structural and Functional Overview
3.0 Method of Managing Routing of Data Elements
4.0 Implementation Mechanisms-Hardware Overview
5.0 Extensions and Alternative
   1.0 General Overview

The needs identified in the foregoing Background, and other needs and objects that will become apparent for the following description, are achieved in the present invention, which comprises, in one aspect, a method for managing routing of data elements, each having a plurality of characteristics having a respective attribute, in a data communications network. The method comprises creating a flow record of data elements having common attributes for one or more tracked characteristics; defining said flow record as a trackable object; tracking a state change of said trackable object; and performing a routing management step upon occurrence of a tracked state change.

In other aspects, the invention encompasses a computer apparatus and a computer-readable medium configured to carry out the foregoing steps.

2.0 Structural and Functional Overview

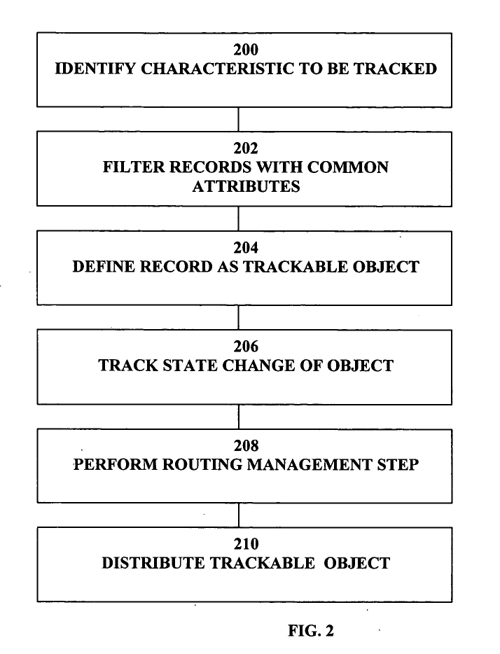

In overview a method of managing routing of data elements can be understood with reference to FIG. 2 which is a flow diagram illustrating steps performed according to the method performed, for example at or in relation to a router in the AS. At step 200 a flow characteristic to be tracked is identified. This can be done manually, for example by a network administrator, or can be detected automatically from flow behaviour. For example the characteristic to be tracked may comprise source and destination addresses and ports. At step 202 records with common attributes for the selected characteristics are filtered such that only those flows with specific pre-determined source and destination addresses and ports are retained and non-interesting flows are excluded.

At step 204 the filtered flow record is defined as a trackable object and at step 206 state changes of the object are tracked. For example the state change may comprise the creation or removal of the flow record or the flow record value such as number of packets or number of bytes exceeding or falling below respective pre-determined threshold values. Defining a filtered flow record as a trackable object may comprise, for example, using Enhanced Object Tracking (EOT) to track the record, as described further below. At step 208, on occurrence of a tracked state change a routing management step is performed. This may be, for example, rerouting of flows, changing of network metrics, diverting flows to a security management application or determination of flows dependent on the policy implemented. At step 210 the trackable object is distributed to other routers in the network in order that similar routing management steps can be implemented elsewhere on the network. Receiving routers can determine that the object is trackable using EOT.

For example where a malicious flow has been identified at a router it is characterized as a trackable object which is then distributed to other routers such that appropriate security steps can be implemented across the network. When a remote router receives the trackable object, therefore, it will detect that the object is trackable using EOT, implement the steps generally set out in FIG. 2 accordingly and in particular track state changes of the object and perform appropriate routing management steps.

As a result enhanced flexible routing is enabled based on traffic measurements and statistics derivable from flow records to provide flexible flow based routing. Use of packet header inspection, traffic patterns and pattern treatment provides optimal information through a range of implementations as described in more detail below.

3.0 Method of Managing Routing of Data Elements

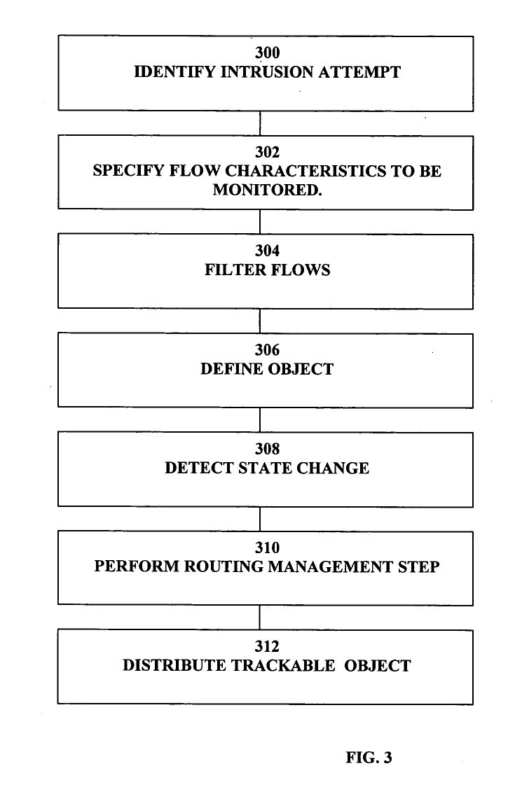

The method can be understood further with reference to FIG. 3 which is a flow diagram showing in more detail steps performed according to the method in a network security management implementation.

At step 300 an intrusion attempt is identified by an external application such as ARBOR, Protego, or Cisco Security MARS. In one example, an intrusion attempt has characteristics. Source/destination addresses: 1.1.1.1/2.2.2.2 Source/destination port: many/80

At step 302 the flow characteristics to be monitored are specified. In particular flexible NetFlow is used to specify the keys or characteristics defining a flow such as source and destination IP address, source and destination ports, protocol identifier, type of service and so forth. In addition values, in the form of record values, can be specified comprising extra information such as number of packets or number of bytes. As a result specific cache visibility is provided in terms of flow level details based on the specified requirements. In the current example the defined flow keys or characteristics are source address (src-addr), destination address (dst-addr) and destination port (dst-port). In addition flow record values comprising of number of packets (Nbr Packets) and the number of bytes (Nbr Bytes) are defined.

At step 304 the flows are filtered to remove non-interesting flow records. For example, filtering involves using an access-list applied to the flows defined in step 302, and cached in a NetFlow cache, allowing pre-filtering of traffic. In the example described here the filter can be applied to allow flows with source address 1.1.1.1 AND destination address 2.2.2.2 AND destination port 80 and to deny all other flows. As a result the suspicious flow, which has been determined by the external application in step 300, is described as a single flow record entry in the cache.

At step 306 the flow record obtained is characterised by the definition of an object whose status is to be tracked. This can be implemented, for example, using Enhanced Object Tracking (EOT), which feature will be familiar to the skilled reader and is described in “Enhanced Object Tracking” which is available at the time of writing on the file “fth/fthsrptk” in the directory “univercd/cc/td/doc/product/software/ios122/122newft/122t/122t15” of the domain “cisco.com” of the World Wide Web. Implementation of the EOT feature will be well known to the skilled reader and so is only described in summary here. In particular EOT creates a stand alone tracking process in order to monitor the status of different objects allowing an external process to register to the EOT process and take appropriate actions based on object status change.

At step 308 a state change is detected. Various states are possible, for example existence of the object meaning that a flow has been identified, threshold over a given value, where the record value such as number of bytes or packets is above a given threshold for a given time window, or threshold below a given value where the value of the object is below a given threshold for a given time window. In the example given, therefore, appropriate rules can be defined. For example if the number of packets per second (NbrPackets/second) is higher than 1000 then the change may be detected. Similarly if the number of packets per second is lower than 500 then again a state change may be identified. The rules may be set in such a way that they remain active for a duration of a pre-determined number of hours or days even if the object does not exist allowing the router to react quickly to further identical malicious attempt.

At step 310 the appropriate routing management steps can be taken upon detection of the state change. This may be achieved, for example, by implementation of an appropriate policy such that the router performs corrective actions such as installing or removing a policy that will discard packets belonging to the flow and/or encapsulate (if necessary) and redirect traffic towards a packet pay load analyser for further inspection, or any other appropriate routing management step. In the example described if NPR packets/second is higher than 1000 then the policy applied may be that any packets within the flow are simply dropped whereas if NPR packet/second is lower than 500 then the previously applied policy may be removed by this flow. As a result it will be see that the flexible flow based routing can be implemented.

At step 312 the object that has been created can be distributed to other routers in order for them to react similarly in the case of a corresponding detected flow, for example, an identical malicious attempt. In particular the object definition, creation and tracking together with the corrective action information can be distributed to any other router that may be subject to the same security issue allowing faster reaction as there is no reliance on initial detection mechanisms.

As a result a system is provided allowing dynamic adaptation to intrusion attempts incorporating a co-operative mechanism between intrusion attempt to detection and subsequent routing decision. In particular where malicious attempts are detected by determination of specific flow behaviour in an external application such as Arbor, Protego, or Cisco Security MARS, a trackable objection is automatically created to allow appropriate policy-based actions to be taken, and the process to be exported to other routers by distribution of the object and associated policies and actions.

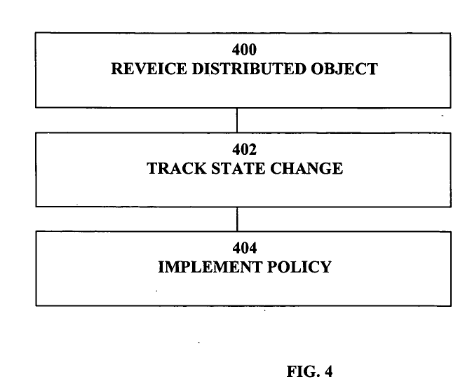

The steps taken at a remote router receiving the distributed object can be understood in more detail with reference to FIG. 4 which is a flow diagram illustrating the steps performed. In particular at step 400 the router receives the distributed object and associated policies, at step 402 tracks the object state changes and at step 404 implements policies as appropriate. It will be appreciated, of course, that each router may additionally define its own objects in the manner described above with reference to FIG. 3 and distribute them as well as implementing objects and policies received from other routers.

It will further be seen that the approach described herein can be implemented in a range of routing management implementations in addition to network security management implementations.

It will be seen that any flow record characteristics or parameters can be monitored including packet header fields, for example destination IP address, destination port number, packet characteristics for example label stack depth in Multi Protocol Label Switching (MPLS) packets, packet processing or treatment derived, for example nexthop IP address, output interface and so forth. In addition any appropriate routing management steps can be taken dependent on the status of the object tracked, for example different routing changes can be propagated, such as IGP metric changes, Equal Cost Multi Path (ECMP) route insertion, policy based routing, BGP changes, static route insertion, and discarding of packets for example by “black-holing” static routes to null 0.

In all of these cases it will further be seen that a trackable object can be created which can be tracked within a given router and also distributed to other routers to propagate relevant treatment of flow behaviour across the network. Further, appropriate behaviour can be detected automatically to trigger creation and tracking of an object either by virtue of an external application or by virtue of appropriately implemented policies.

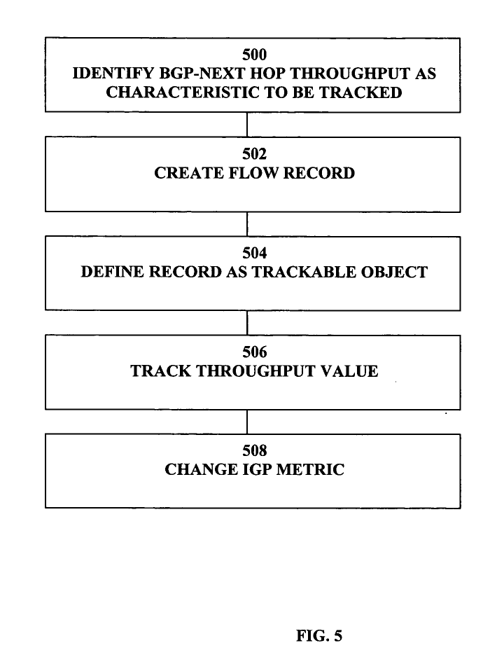

For example referring to FIG. 5, which is a flow diagram showing an implementation of the approach in network-wide capacity planning, appropriate steps can be seen. At step 500 the characteristic to be tracked is identified which in this case is the throughput per BGP-nexthop, that is, the number of packets sent from an edge router to each nexthop in another AS, and an appropriate flow record is created and filtered at step 502. At step 504 the record is defined as a trackable object and at step 506 the status of the object is tracked to identify whether the throughput exceeds a pre-determined value. In that case, at step 508, IGP metrics can be changed as appropriate in order to accommodate the extra load without losing traffic. The IGP metric changes will allow the network to discover an alternate path to the BGP nexthop for example via an alternative BGP edge router, that can accommodate any required bandwidth/delay/cost resources.

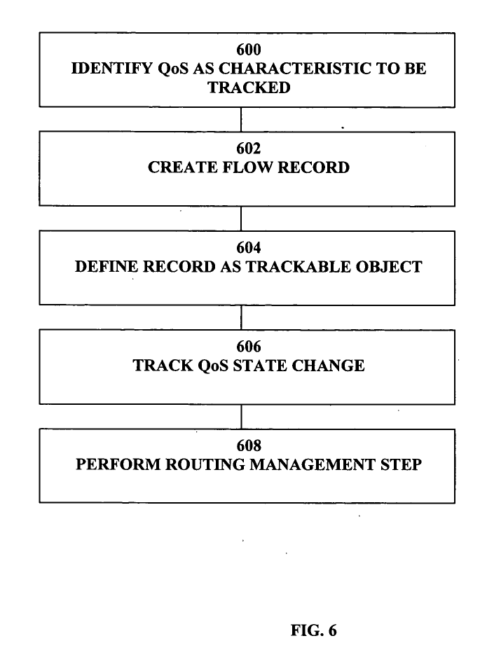

In an alternative arrangement, where agreements are in place between parties such as internet service providers (ISP) and customers or other peers, satisfaction of the agreement terms can be implemented using the approaches described herein. FIG. 6 is a flow diagram illustrating the steps performed implementing the method in the domain of quality of service (QoS) covered by a Service Level Agreement (SLA). At step 600 QoS is identified as the characteristic to be tracked and at step 602 an appropriate flow record is created and defined as a trackable object in step 604. At step 606 state changes are tracked corresponding to QoS state changes and, at step 608, depending on a state change, the appropriate routing management step is performed for example as defined in a management policy. For example where service level agreements require a certain QoS then monitoring flow records per QoS can allow optimization of the IGP metrics in order to respect the SLAs.

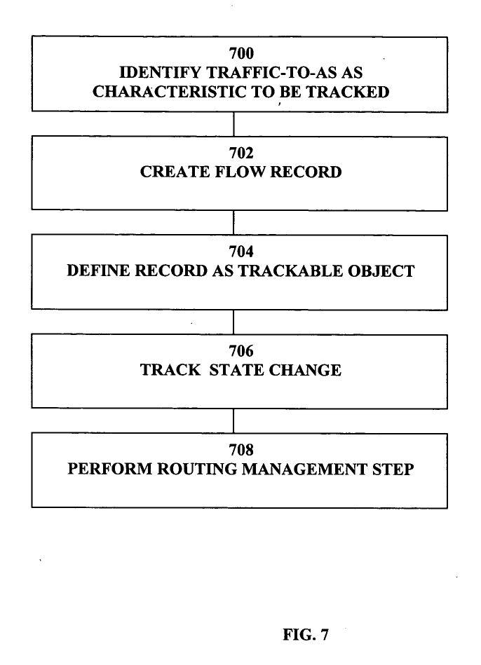

FIG. 7 shows implementation of the steps of the matter described herein in the domain of a Peering Agreement. At step 700 traffic to an AS is identified as the characteristic to be tracked, at step 702 a flow record is created and this is defined as a trackable object at step 704. At step 706 an appropriate state change is tracked, for example an ISP can identify when the throughput towards/via a specific AS reaches a certain threshold. In that case, at step 708 the appropriate routing management step is performed, for example rerouting the BGP traffic appropriately. Alternatively, at step 706, an ISP can track incoming traffic received from a neighbour BGP peer, in which case the flow record is monitored by source interface, source AS, prefix or source BGP nexthop, for example. This is then compared with traffic sent to the neighbour in the case of an agreement where traffic between external BGP peers should be matched. In that case where the outgoing traffic exceeds incoming traffic from that peer then extra traffic can be sent via a different route.

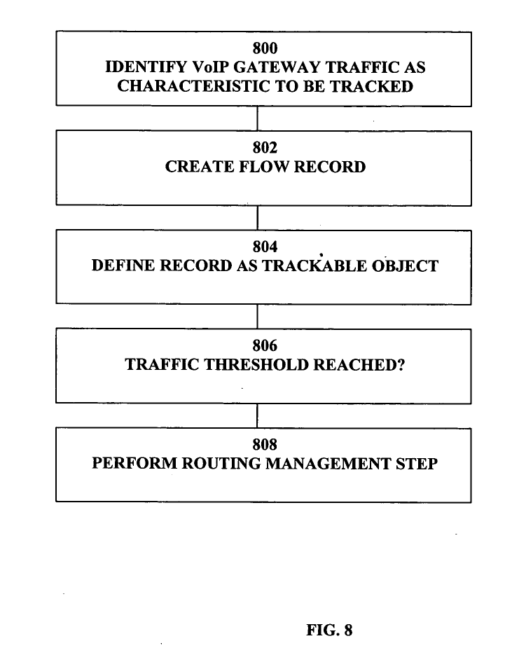

FIG. 8 is a flow diagram illustrating steps performed in implementing the method in the case of voice over IP (VoIP) traffic. In this case, at step 800 the VoIP gateway traffic is identified as the tracked characteristic, an appropriate flow record is created at step 802 and defined as a trackable object at step 804. At step 806 the object state is tracked in particular to identify whether the traffic threshold is reached in which case at step 808 the appropriate routing management step is performed for example adding a second ECMP in the IGP in order to respect the SLA supporting VoIP traffic.

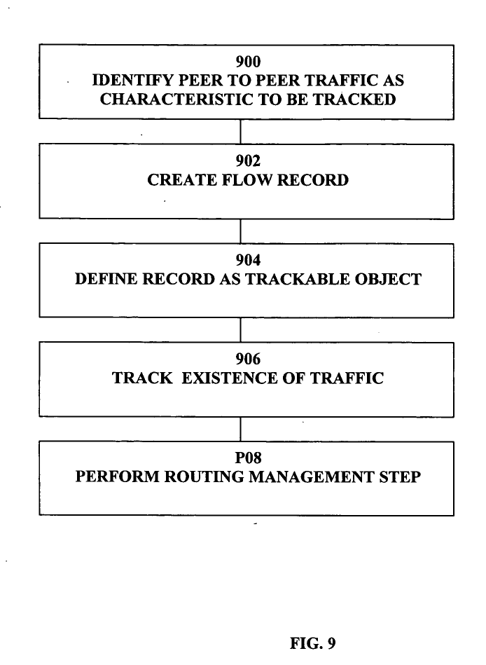

Yet a further improvisation is shown in FIG. 9 which is a flow diagram showing steps involved in implementing the method described here in the domain of traffic monitoring. In this case the characteristic to be tracked is peer to peer traffic at step 900 and an appropriate flow record is created at step 902 and defined as a trackable object at step 904. At step 906 the existence of peer to peer traffic is tracked, and once said traffic is detected, then at step 908 the ISP can implement policy based routing to route such traffic via a sub-optimal route.

It will be seen that in all of these alternative implementations, the object can then be distributed as appropriate. In addition initial identification and creation of objects can be implemented automatically as appropriate.

It will further be seen that the approach as described above can be implemented in any appropriate manner for example on any router platform or other network device and in relation to a network of any type and scale including large service providers and enterprise networks. It will be appreciated by the skilled reader that the steps described herein can be implemented in any appropriate manner, for example by incorporating appropriate code or instructions into existing flow monitoring applications and object tracking applications such that detailed description is not required herein.

4.0 Implementations Mechanisims—Hardware Overview

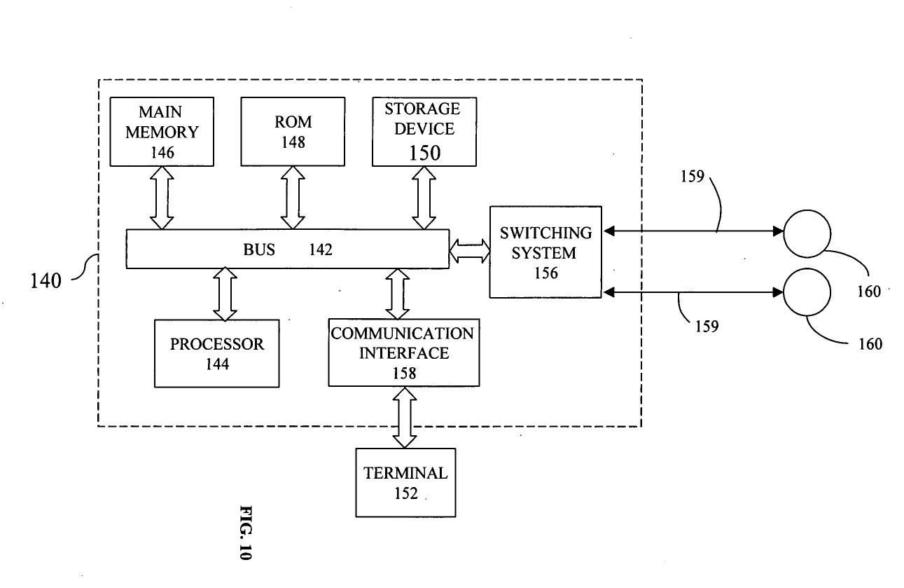

FIG. 10 is a block diagram that illustrates a computer system 140 upon which the method may be implemented. The method is implemented using one or more computer programs running on a network element such as a router device. Thus, in this embodiment, the computer system 140 is a router.

Computer system 140 includes a bus 142 or other communication mechanism for communicating information, and a processor 144 coupled with bus 142 for processing information. Computer system 140 also includes a main memory 146, such as a random access memory (RAM), flash memory, or other dynamic storage device, coupled to bus 142 for storing information and instructions to be executed by processor 144. Main memory 146 may also be used for storing temporary variables or other intermediate information during execution of instructions to be executed by processor 144. Computer system 140 further includes a read only memory (ROM) 148 or other static storage device coupled to bus 142 for storing static information and instructions for processor 144. A storage device 150, such as a magnetic disk, flash memory or optical disk, is provided and coupled to bus 142 for storing information and instructions.

A communication interface 158 may be coupled to bus 142 for communicating information and command selections to processor 144. Interface 158 is a conventional serial interface such as an RS-232 or RS-422 interface. An external terminal 152 or other computer system connects to the computer system 140 and provides commands to it using the interface 158. Firmware or software running in the computer system 140 provides a terminal interface or character-based command interface so that external commands can be given to the computer system.

A switching system 156 is coupled to bus 142 and has an input interface and a respective output interface (commonly designated 159) to external network elements. The external network elements may include a plurality of additional routers 160 or a local network coupled to one or more hosts or routers, or a global network such as the Internet having one or more servers. The switching system 156 switches information traffic arriving on the input interface to output interface 159 according to pre-determined protocols and conventions that are well known. For example, switching system 156, in cooperation with processor 144, can determine a destination of a packet of data arriving on the input interface and send it to the correct destination using the output interface. The destinations may include a host, server, other end stations, or other routing and switching devices in a local network or Internet.

The computer system 140 implements as a router or network component the above described method. The implementation is provided by computer system 140 in response to processor 144 executing one or more sequences of one or more instructions contained in main memory 146. Such instructions may be read into main memory 146 from another computer-readable medium, such as storage device 150. Execution of the sequences of instructions contained in main memory 146 causes processor 144 to perform the process steps described herein. One or more processors in a multi-processing arrangement may also be employed to execute the sequences of instructions contained in main memory 146. In alternative embodiments, hard-wired circuitry may be used in place of or in combination with software instructions to implement the method. Thus, embodiments are not limited to any specific combination of hardware circuitry and software.

The term “computer-readable medium” as used herein refers to any medium that participates in providing instructions to processor 144 for execution. Such a medium may take many forms, including but not limited to, non-volatile media, volatile media, and transmission media. Non-volatile media includes, for example, optical or magnetic disks, such as storage device 150. Volatile media includes dynamic memory, such as main memory 146. Transmission media includes coaxial cables, copper wire and fiber optics, including the wires that comprise bus 142. Transmission media can also take the form of wireless links such as acoustic or electromagnetic waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 144 for execution. For example, the instructions may initially be carried on a magnetic disk of a remote computer. The remote computer can load the instructions into its dynamic memory and send the instructions over a telephone line using a modem. A modem local to computer system 140 can receive the data on the telephone line and use an infrared transmitter to convert the data to an infrared signal. An infrared detector coupled to bus 142 can receive the data carried in the infrared signal and place the data on bus 142. Bus 142 carries the data to main memory 146, from which processor 144 retrieves and executes the instructions. The instructions received by main memory 146 may optionally be stored on storage device 150 either before or after execution by processor 144.

Interface 159 also provides a two-way data communication coupling to a network link that is connected to a local network. For example, the interface 159 may be an integrated services digital network (ISDN) card or a modem to provide a data communication connection to a corresponding type of telephone line. As another example, the interface 159 may be a local area network (LAN) card to provide a data communication connection to a compatible LAN. Wireless links may also be implemented. In any such implementation, the interface 159 sends and receives electrical, electromagnetic or optical signals that carry digital data streams representing various types of information.

The network link typically provides data communication through one or more networks to other data devices. For example, the network link may provide a connection through a local network to a host computer or to data equipment operated by an Internet Service Provider (ISP). The ISP in turn provides data communication services through the world wide packet data communication network now commonly referred to as the “Internet”. The local network and the Internet both use electrical, electromagnetic or optical signals that carry digital data streams. The signals through the various networks and the signals on the network link and through the interface 159, which carry the digital data to and from computer system 140, are exemplary forms of carrier waves transporting the information.

Computer system 140 can send messages and receive data, including program code, through the network(s), network link and interface 159. In the Internet example, a server might transmit a requested code for an application program through the Internet, ISP, local network and communication interface 158. One such downloaded application provides for the method as described herein.

The received code may be executed by processor 144 as it is received, and/or stored in storage device 150, or other non-volatile storage for later execution. In this manner, computer system 140 may obtain application code in the form of a carrier wave.

5.0 Extensions and Alternatives

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense. Aspect or examples or embodiments described can be juxtaposed or interchanged as appropriate.

It will be seen that the method described herein can be implemented in relation to any routing management steps example rerouting using BGP, IGP or a static route and so forth and based on any forwarding paradigm. The approach can be implemented in relation to any application capable of creating and tracking appropriate objects and any flow monitoring application. Furthermore any appropriate behaviour can be detected by defining parameters of network traffic and creating appropriate flow records.

What is claimed is:

1. A method of managing routing of data elements, each having a plurality of characteristics having a respective attribute, in a data communications network, comprising:
creating a flow record of data elements having common attributes for one or more tracked characteristics;
defining said flow record as a trackable object;
tracking a state change of said trackable object; and
performing a routing management step upon occurrence of a tracked state change.

2. A method as claimed in claim 1 in which the tracked characteristic comprises at least one of a packet header field characteristic, a packet characteristic, or a packet processing/treatment derived characteristic.

3. A method as claimed in claim 1 in which the tracked characteristic is identified from flow behaviour.

4. A method as claimed in claim 1 in which the flow record is created by filtering out data elements which do not have the common attribute for the one or more tracked characteristics.

5. A method as claimed in claim 1 in which the flow record has a record value and a state change occurs if the record value meets a state change criterion.

6. A method as claimed in claim 5 in which the record value comprises at least one of the number of bytes or the number of packets.

7. A method as claimed in claim 5 in which the state change criterion comprises at least one of the record value exceeding or falling below a respective state change threshold, or creation of said flow record.

8. A method as claimed in claim 1 in which the routing management step comprises at least one of an interior gateway protocol metric change, an equal cost multi-path route insertion, policy based routing, a border gateway protocol change, static route insertion, discarding of data element, diversion of data elements, or the termination of a previous routing management step.

9. A method as claimed in claim 1 further comprising distributing a trackable object amongst one or more network components.

10. A method as claimed in claim 1 comprising a method of managing network security, in which the tracked characteristic comprises at least one of a source or destination address or port and the routing management step comprises at least one of discarding data elements or diverting data elements.

11. A method as claimed in claim 1 comprising a method of network capacity planning in which the tracked characteristic comprises Border Gateway Protocol nexthop throughput and the routing management step comprises providing an alternate path to the Border Gateway Protocol nexthop.

12. A method as claimed in claim 1 comprising a method of maintaining a service provision agreement.

13. A method as claimed in claim 12 in which the service provision agreement comprises one of a Quality of Service agreement, a peering agreement or a voice over IP provision agreement and the routing management step comprises one of, respectively, optimization of interior gated protocol metrics, rerouting of excess traffic or rerouting of traffic to respect a service provision agreement.

14. A method as claimed in claim 1 comprising a method of traffic monitoring in which the tracked characteristic comprises peer-to peer traffic and the routing management step comprises policy based routing.

15. A method as claimed in claim 1 in which the trackable object comprises an Enhanced Object Tracking object.

16. A method of managing routing of data elements, each having a plurality of characteristics having a respective attribute, in a data communications network, comprising:
receiving, as a trackable object, a flow record of data elements having common attributes for one or more tracked characteristic;
tracking a state change of said trackable objects; and
performing a routing management step upon occurrence of a tracked state change.

17. A computer readable medium comprising one or more sequences of instructions which, when executed by one or more processors, cause the one or more processors to perform the steps of the method of claim 1 or 16.

18. An apparatus for managing routing of data elements comprising:
one or more processors; and
a network interface communicatively coupled to the one or more processors and configured to communicate one or more packet flows among the one or more processors in the network, and a computer readable medium comprising one or more sequences of instructions which, when executed by the one or more processors, cause the one or more processors to perform the steps of the methods of claim 1 or 16.

19. An apparatus for managing routing of data elements comprising each having a plurality of characteristics having a respective attribute, in a data communications network, comprising:
means for creating a flow record of data elements having common attributes for one or more tracked characteristics;
means for defining said flow record as a trackable object;
means for tracking a state change of said trackable object; and means for performing a routing management step upon occurrence of a tracked state change
